(19) United States
(12) Patent Application Publication
(10) Pub. No.: US 2017/0068570 A1
(43) Pub. Date: Mar. 9, 2017

(54) SYSTEM FOR MANAGING ASSET MANAGER LIFETIMES

(71) Applicant: Apple Inc., Cupertino, CA (US)

(72) Inventor: Evan G. LONG, Palo Alto, CA (US)

(21) Appl. No.: 14/869,958

(22) Filed: Sep. 29, 2015

Related U.S. Application Data
(60) Provisional application No. 62/215,271, filed on Sep. 8, 2015.

(51) Int. Cl. G06F 9/50; G06F 12/08; G06F 9/445

(52) U.S. Cl. CPC G06F 9/5011; G06F 8/62; G06F 8/65; G06F 12/0875; G06F 2212/603

(57) ABSTRACT

This application relates to systems, methods, and apparatuses for managing assets of an application of a computing device using asset managers. Specifically, the embodiments herein are set forth to manage the lifetime of asset managers based on whether a module of the computing device is using the asset managers. When an application is updated, certain modules of the computing device may need to access the updated assets of the application. In order to correctly reference the updated assets, the module can request a volatile resource using a set of unique identifiers for the updated application. Thereafter, volatile resource can reference an asset manager and the assets of the application until the module determines that another update has been installed at the computing device. In this way, the lifetime of the asset manager is determined by the module, rather than being directly based on an update to an application.

### CROSS-REFERENCE TO RELATED APPLICATIONS

The present application claims the benefit of U.S. Provisional Application No. 62/215,271, entitled “SYSTEM FOR MANAGING ASSET MANAGER LIFETIMES” filed Sep. 8, 2015, the content of which is incorporated herein by reference in its entirety for all purposes.

### FIELD

The described embodiments relate generally to managing assets for an application of a computing device. More particularly, the present embodiments relate to managing the lifetime of asset managers to avoid system failures when expired assets are referenced by a module of the computing device.

### BACKGROUND

Many computing devices have a variety of applications that can be associated with different assets that are used during operation of the applications. However, over time these applications may be subject to updates that change their respective assets. For example, a computing device may display a home screen that includes assets such as icons for each application. A module responsible for arranging the home screen may reference these assets, as well as any new assets that were created during an application update, in order to correctly arrange the home screen. If the new assets are not referenced correctly, the module or the computing device may crash resulting in a potential loss of data and a poor user experience.

### SUMMARY

This paper describes various embodiments that relate to systems, methods, and apparatuses for managing assets of an application of a computing device. In some embodiments, a method for generating an asset manager for an application is set forth. The method can include the steps of receiving a request, from a module of a computing device, to access an asset of an application, and generating an asset manager that corresponds to the application. The method can further include a step of providing the module with a volatile resource that is configured to provide the module with access to the asset through the asset manager.

In other embodiments, a computing device is set forth. The computing device can include a processor and a memory, which can be configured to store instructions that when executed by the processor cause the computing device to perform steps that include sending an asset request to an asset manager cache. The steps can further include receiving a volatile resource from the asset manager cache. The volatile resource can reference an asset and an asset manager, which is created by the asset manager cache. Furthermore, the volatile resource can provide a module access to an asset of an application. The asset request can include a key that is generated based on an identifier of the application and an installation path of the application.

In yet other embodiments, a system for managing application assets on a computing device is set forth. The system can include an asset manager cache configured to generate a volatile resource in response to an asset request. The volatile resource can be configured to provide access to an asset associated with an application on the computing device. The system can further include a module configured to provide the asset request to the asset manager cache and access the asset using the volatile resource. The volatile resource can be available to the module after an updated version of the application has been installed on the computing device.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1A illustrates a perspective view of a computing device that can operate using the asset manager lifetime cache (AMLC) discussed herein.

FIG. 1B illustrates a system diagram of the computing device.

FIG. 2 illustrates a system diagram for the computing device when a first version (V1) of an application is installed on the computing device.

FIG. 3 illustrates a system diagram of a version of an application being updated at the computing device.

FIG. 4 illustrates a system diagram of the AMLC generating a key entry V2 and an asset manager entry V2.

FIG. 5 illustrates a system diagram of the module receiving the volatile resource V2.

FIG. 6 illustrates a system diagram of the computing device when the application V2 is removed from the computing device.

FIG. 7 illustrates a system diagram of the daemon notifying the module that the application V2 has been removed from the computing device.

FIG. 8 illustrates a system diagram of the module after having relinquished the volatile resource V2.

FIG. 9 illustrates a method for providing a volatile resource to a module of a computing device in order for the module to access an asset of an application through the volatile resource.

FIG. 10 illustrates a method for accessing an asset of an application using a volatile resource.

FIG. 11 illustrates a method for obtaining access to an updated asset of an updated application through a volatile resource.

FIG. 12 is a block diagram of a computing device that can represent the components of the computing device.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

Many computing devices can operate a variety of applications that occasionally require updates in order to improve their functionality and remain compatible with the computing device on which they are installed. As a result, many modules of the computing device can also be updated in order to ensure that communications between the updated applications and the modules are adequately maintained. A module can be, for example, a software module responsible for maintaining icons on a home screen of a device. When an application associated with an icon on the home screen is subject to an update, the module will need to remove a link between the icon and the module in order to link the module to an updated icon. However, if linking is not performed correctly, the module and/or the computing device may crash, resulting in a potential loss of data and an overall poor user experience. For example, if the previous icon is deleted from the computing device without relinking the module to the updated icon, the module will be unable to display a link for a corresponding application.

The embodiments provided herein are set forth to resolve the aforementioned issues. Specifically, the issues concern how access to application assets is managed within a computing device. The computing device can include various assets that are related to the operation of a corresponding application. The assets are linked to different asset managers that are used by various modules of the computing device. When an asset manager is removed from a module as a result of an application update, the corresponding assets may be rendered invalid, and attempts to access the corresponding assets can result in the module or computing device crashing. In order to resolve this issue, a correspondence between an existing asset manager or a resource of the existing asset manager can be maintained until a new asset manager is created for an updated application. Additionally, this correspondence can be maintained by a module to ensure that the resource is not prematurely removed from the computing device before a new asset manager is accessible to the module.

In order for the module to continue accessing assets of an application, a volatile resource can be created for one or more modules. The volatile resource can reference both an asset manager and an asset, such as an image, which can also be referenced by the asset manager. The asset manager can expire after a module determines that an updated application exists. In response to this determination, the module can make a request to an asset manager lifetime cache (AMLC) to retrieve a new asset manager. The AMLC can create asset managers in response to requests from the module. The creation of an asset manager by the AMLC can be independent of the updates performed on an application. Therefore, the AMLC may not create an asset manager until the module makes a request to an asset manager. In this way, the module can be in control of when asset managers expire, thereby making a more efficient use of the memory of the computing device.

Further details of the AMLC can be understood through an example of how a module can reference a new asset manager after an application update has been installed. The application can be any software application for a computing device that includes a file of assets corresponding to images, text, sound, and other data for running the application. The module can also be any software application that uses assets of another application during operation of the module. The module can identify an application using one or more identifiers such as, but not limited to, a bundle identifier, an install path, and a modification time. The bundle identifier corresponds to a name used by the computing device to identify the application. The install path corresponds to an address of the directory or container in which the application is installed, and the modification time corresponds to data that identifies a time when the install path was modified during an application update or installation. By allowing the module to identify an application by other identifiers beyond the bundle identifier, the module can maintain a one to one relationship with a version of an application that can be a previous version or an updated version of the application. Once the application has been updated, the module can be provided new identifiers by a system daemon, and thereafter use the new identifiers to access updated application assets.

In order for the module to access the updated application assets, the module will send a request with the new identifiers, provided by the system daemon, to an AMLC of the module. In response to the request, the AMLC will provide a volatile resource to the module. The volatile resource can be provided to the module along with access to a new asset manager and one or more assets for the updated application. One or more modules can access the assets of the updated application using the volatile resource, even after a newer version of the updated application has thereafter been installed. When the newer version of the updated application is installed, the AMLC can generate another asset manager for the newer version without interfering with the asset manager and volatile resource there were provided to the module. The module can continue to access assets through the asset manager and the volatile resource until identifiers for the newer version of the application are provided to the module. When identifiers for the newer version of the application are provided to the module, the module can again use the new identifiers to request a new asset manager from the AMLC, thereby ending the life of the asset manager currently being used by the module. In other words, the duration of time that the module is referencing an asset manager can determine the lifetime of the asset manager.

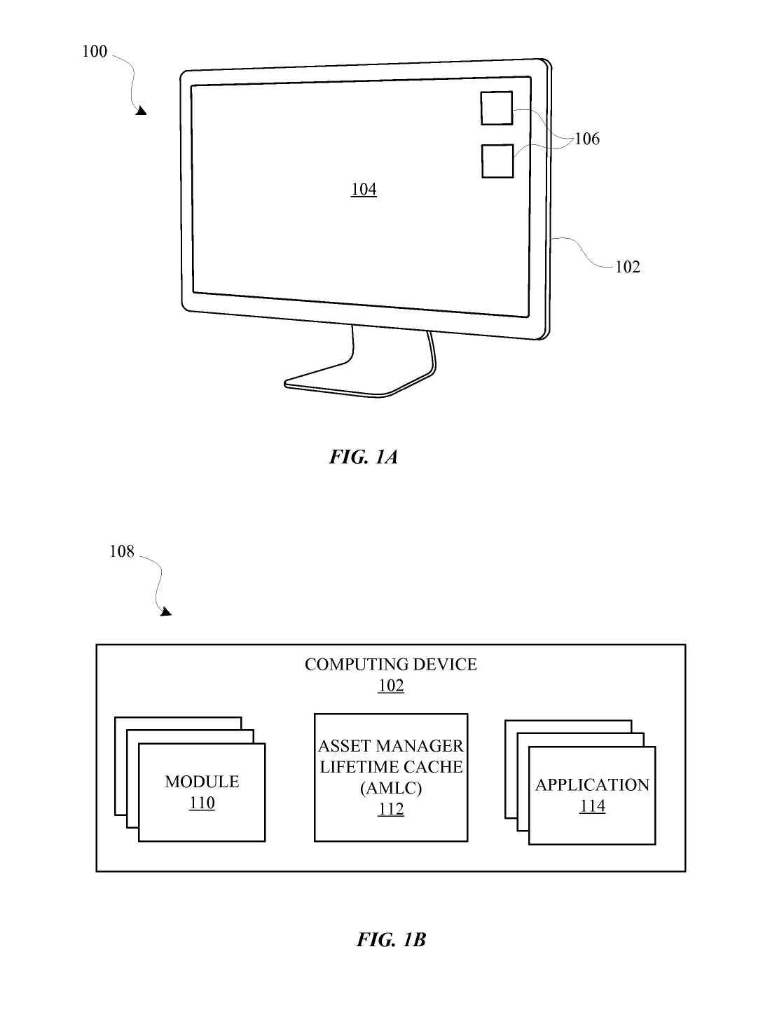

These and other embodiments are discussed below with reference to FIGS. 1A-12; however, those skilled in the art will readily appreciate that the detailed description given herein with respect to these figures is for explanatory purposes only and should not be construed as limiting.

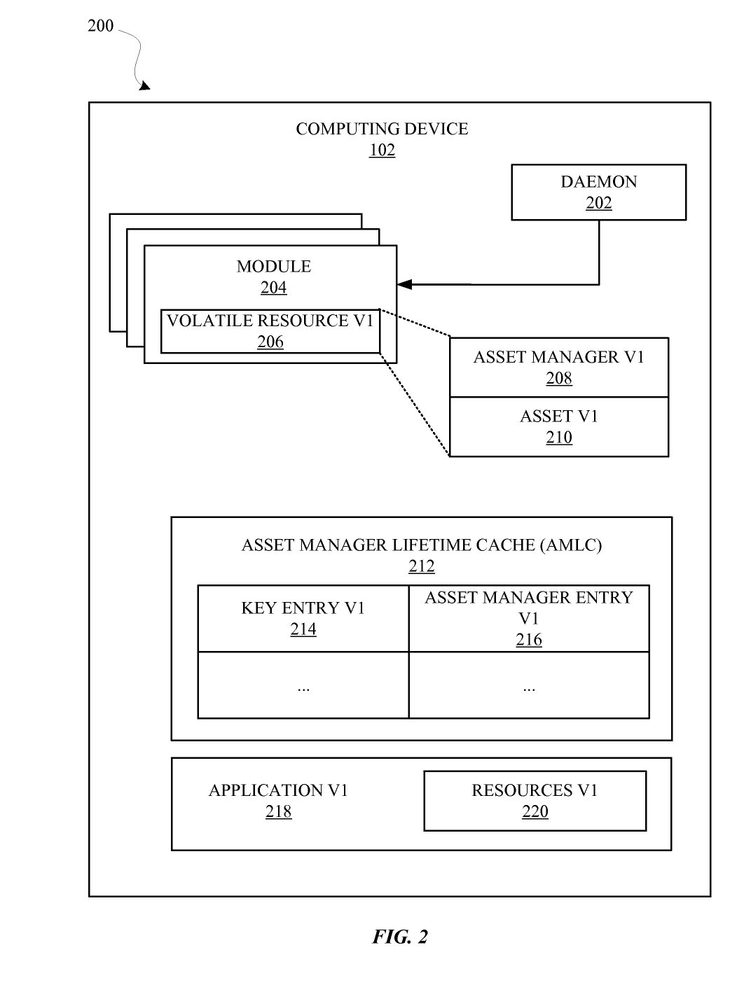

FIG. 1A illustrates a perspective view 100 of a computing device 102 that can operate using the asset manager lifetime cache (AMLC) discussed herein. The computing device 102 can be any device including, but not limited to, a desktop, laptop, cellular phone, media player, tablet, television, or any other suitable device capable of operating one or more applications. The computing device 102 can include a display 104 that can display one or more icons 106, which represent certain applications on the computing device 102. The icons 106 can change as their corresponding applications are updated and/or removed. Updates can be received from a server over the internet and include new images that can replace current images for the icons 106. In order to manage the arrangement of the icons 106 on the display 104, the computing device 102 can include a module 110, as illustrated in FIG. 1B. Specifically, FIG. 1B illustrates a system diagram 108 of the computing device 102. The computing device 102 can include one or more modules 110 responsible for managing certain data associated with applications 114 during the operation of the computing device 102. This data can be referred to as assets, and can include data such as the images for the icons 106. In order for a module 110 to access the assets of an application 114, the module uses an asset manager generated by an asset manager lifetime cache (AMLC) 112, as discussed herein. As applications 114 are updated and/or removed from the computing device 102, as provided in FIG. 2, the module 110 can be provided access to assets of a version of an application 114 until a new asset manager is provided for the module 110. In this way, errors and crashes caused by failed links between the assets and a module 110 can be avoided.

FIG. 2 illustrates a system diagram 200 for the computing device 102 when a first version (V1) of an application 218 is installed on the computing device 102. It should be noted that any of the modules of the computing device 102 discussed herein can be embodied as executable software stored in one or more memories of the computing device 102, and executable on one or more logic components, such as a processor, of the computing device 102. For example, the computing device 102 can include a daemon 202 that is configured to execute as a background process and notify one or more of the modules 204 and/or the AMLC 212 of whether an application has been removed, installed, updated, or otherwise modified on the computing device 102. The modules 110 can include any software module that can use assets of an application during operation of the module 110. For example, a module 110 can include a home screen module that manages the display of icons for the various applications of the computing device 102. The module 110 can perform certain operations using a volatile resource, such as the volatile resource V1 206 illustrated in FIG. 2. The volatile resource V1 206 can include or reference an asset manager V1 208 and an asset V1 210. During operation of a module 204, should the module 204 need to use the asset V1 associated with an application V1 218, the module 204 will access the volatile resource V1 206. The volatile resource V1 206 can thereafter access the asset manager V1 208 and asset V1 210 in order to provide the module 204 with the asset V1 210. In some embodiment, the asset V1 210 can refer to an image corresponding to a desktop icon for the application V1 218. When the application V1 218 is initially installed, the application V1 218 can include resources V1 220, which can include the asset V1 210. However, to ensure that the module 204 does not have to reference the resources V1 220 in a folder or container of the application V1 218, the module 204 is provided the volatile resource V1 206.

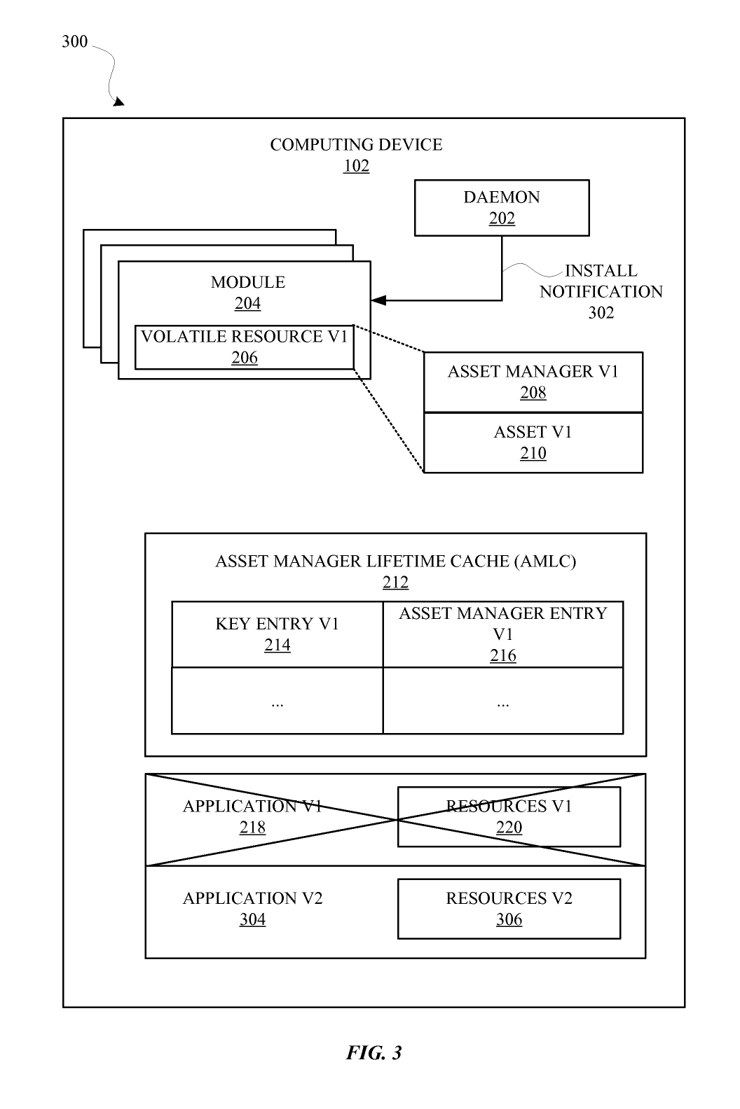

The volatile resource V1 206 is provided to the module 204 by the asset manager lifetime cache (AMLC) 212. The AMLC 212 can manage requests for assets and/or asset managers from the modules 204 of the computing device 102 to ensure that a one to one relationship exists between the modules 204 and the asset managers. For example, the FIG. 2 illustrates how the module 204 uses a volatile resource V1 206 to access an asset manager V1 208 and an asset V1 210. The AMLC 212 includes an entry for the asset manager V1 208, which is labeled asset manager entry V1 216 and is associated with the application V1 218. This entry for the asset manager V1 208 is created in response to the module 204 sending an asset request to the AMLC 212. In response to the asset request, and when no previous entry is associated with the application V1 218, the AMLC 212 creates the key entry V1 214. The key entry V1 214 can remain until an update to the application V1 218 is installed at the computing device 102, as provided in FIG. 3.

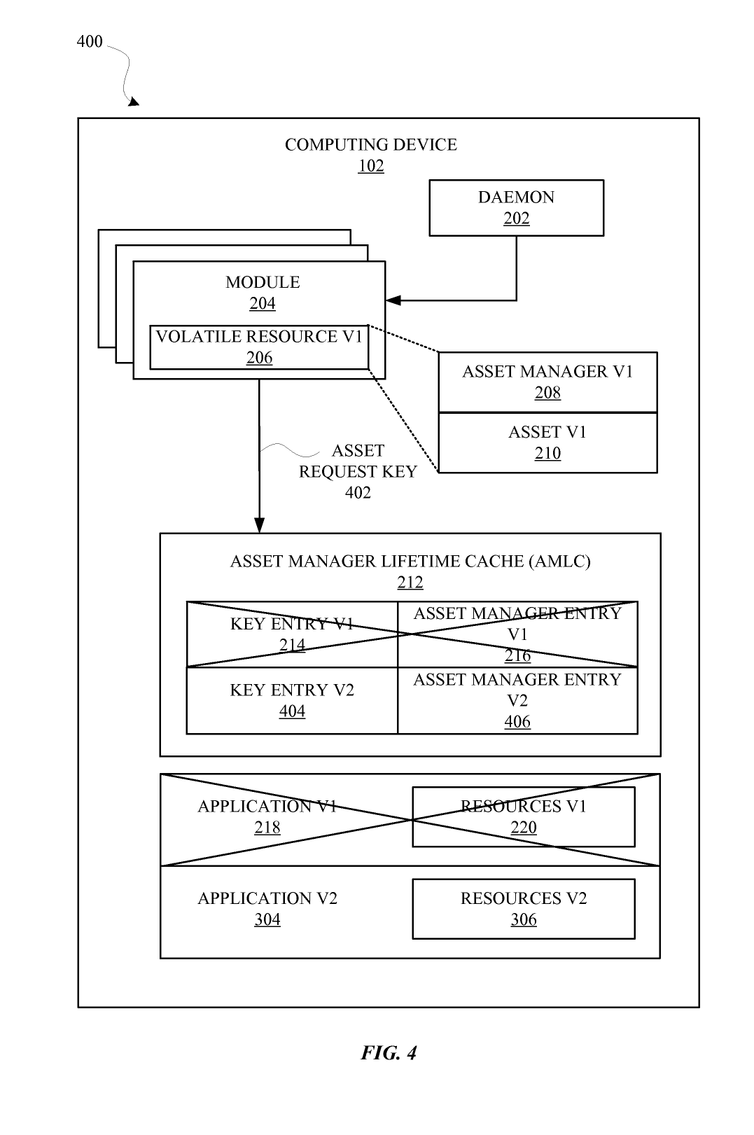

FIG. 3 illustrates a system diagram 300 of a version of an application being updated at the computing device 102. Specifically, FIG. 3 illustrates the application V1 218 and the resources V1 220 being removed from the computing device 102, and the application V2 304 being installed on the computing device 102 with the resources V2 306. It should be noted that the intersecting lines crossing over the application V1 218 and resources V1 220 in FIG. 3 indicate the removal, uninstallation, and/or deletion of the item that is being crossed out by the intersecting lines. These intersecting lines are also used in FIGS. 4-8 and hold the same meaning in FIGS. 4-8.

When the application V1 218 is removed from the computing device 102 and the application V2 304 is installed, the daemon 202 can send an install notification 302 to the modules 204 and/or the AMLC 212. The install notification 302 indicates to the modules 204 that the application V2 304 has been installed and that the application V1 218 has been removed. Although the modules 204 are made aware of the application V2 304 and the removal of application V1 218, the module 204 can still access the volatile resource V1 206. In this way, the module 204 is able to utilize the asset manager V1 208 and asset V1 210 even after the corresponding application V1 218 and resources V1 220 have been removed, as provided in FIG. 4. This can avoid situations where the module 204 is attempting to access the resources V2 306 without having an asset manager for the corresponding application V2 304. The asset manager for the application V2 304 can be created by the AMLC 212 in response to a request from the module 204, as provided in FIG. 4.

FIG. 4 illustrates a system diagram 400 of the AMLC 212 generating a key entry V2 404 and an asset manager entry V2 406. Specifically, FIG. 4 illustrates the AMLC 212 generating the key entry V2 404 and the asset manager entry V2 406 in response to the AMLC 212 receiving an asset request key 402. Even though the daemon 202 made the module 204 aware of the application V2 304, as illustrated in FIG. 3, the module 204 can still use the volatile resource 206 until an updated volatile resource is provided by the AMLC 212. An updated volatile resource can be created using information provided in the asset request key 402. The asset request key 402 can be created by the module 204 using one or more variables associated with the application V2 304. For example, the asset request key 402 can be created using a bundle identifier, which can be used by other modules or subsystems of the computing device 102 to identify the application V2 304. In other words, bundle identifier can be a common term for the computing device 102 to consistently identify the application V2 304. The asset request key 402 can also be created using an address string that identifies a path or address for the application V2 304. For example, the string can identify a drive and folder where the application V2 304 has been installed on the computing device 102. The asset request key 402 can also be created using time data that identifies when the application V2 304 was installed, or when the path of the application V2 304 was last modified. In some embodiments, the asset request key 402 is created using the bundle identifier, the address string, and the time data, or any combination thereof.

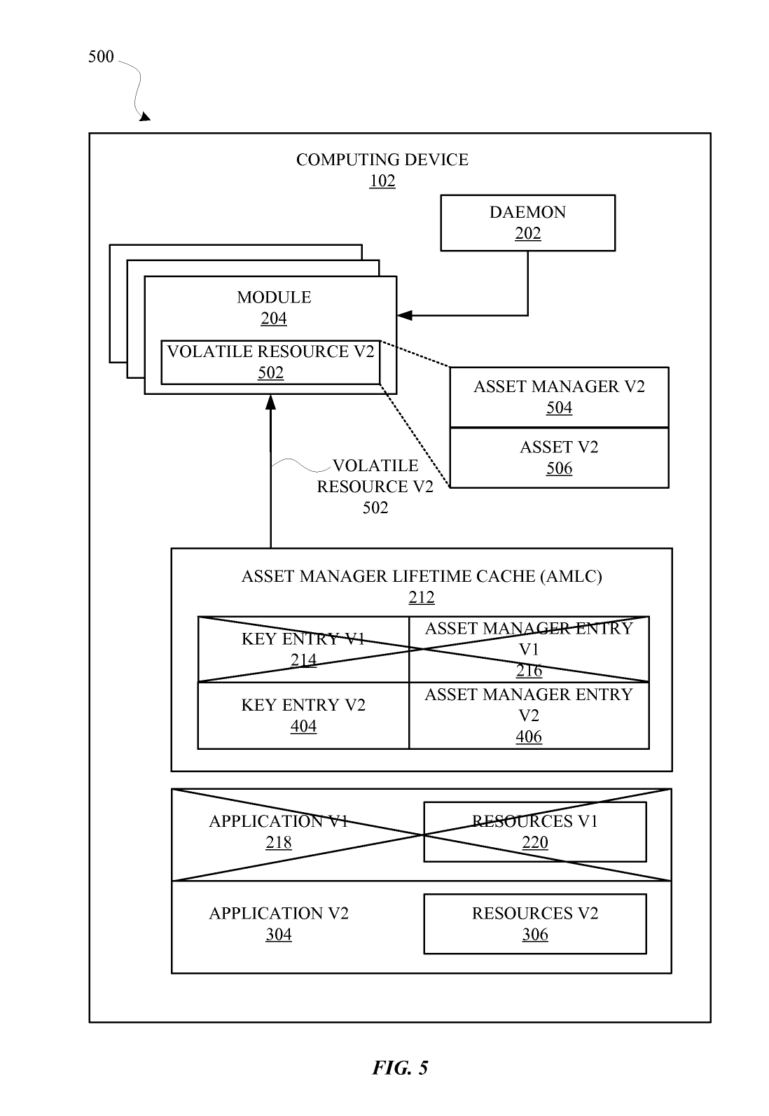

Once the asset request key 402 is received by the AMLC 212, the AMLC 212 can determine that the application V1 218 has been removed and that the application V2 304 has been installed. In response to this determination, the AMLC 212 can generate the key entry V2 404, using the information provided in the asset request key 402, and the asset manager entry V2 406. It should be noted that, in some embodiments, even though the key entry V2 404 and the asset manager entry V2 406 have been created at the AMLC 212, the module 204 may still continue to use the volatile resource V1 206. The module 204 can relinquish use of the volatile resource V1 206 once the AMLC 212 has provided an updated volatile resource, as illustrated in FIG. 5.

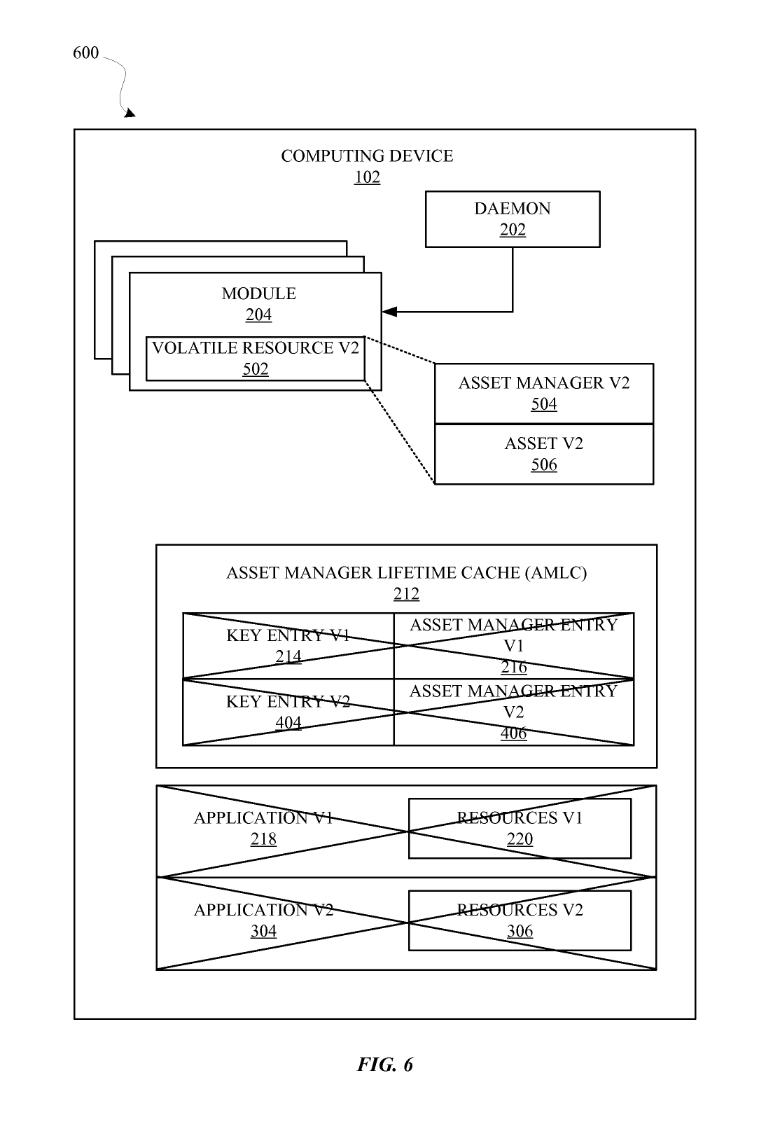

FIG. 5 illustrates a system diagram 500 of the module 204 receiving the volatile resource V2 502. The volatile resource V2 502 can be received in response to the module 204 requesting one or more assets corresponding to the resources 306 of the application V2 304. The volatile resource V2 502 can reference an asset manager V2 504 and an asset V2 506. In this way, whenever the module 204 needs to access an asset corresponding to the application V2 304, the module 204 can access the asset via the volatile resource V2 502. This allows for the module 204 to access the asset V2 506 regardless of whether the application V2 304 is the latest version of the application on the computing device 102. For example, the volatile resource V2 502 can be available to the module 204 even after the application V2 304 has been removed from the computing device 102, as illustrated in FIG. 6.

FIG. 6 illustrates a system diagram 600 of the computing device 102 when the application V2 304 is removed from the computing device 102. The AMLC 212 can determine that the application V2 304 has been removed from the computing device 102 and thereafter remove the key entry V2 404 and the asset manager entry V2 406. In some embodiments, the AMLC 212 determines that the application has been removed from the computing device 102 by receiving a notification from the daemon 202 or the module 204. However, regardless of the removal of the key entry V2 404 and the asset manager entry V2 406 from the AMLC 212, the module 204 is still able to use the asset manager V2 504 and the asset V2 506 via the volatile resource V2 502. Additionally, the module 204 is able to share the volatile resource 206 with other modules 204 in order that the other modules 204 can access the asset manager V2 504 and the asset V2 506 after the application V2 304 has been removed from the computing device 102.

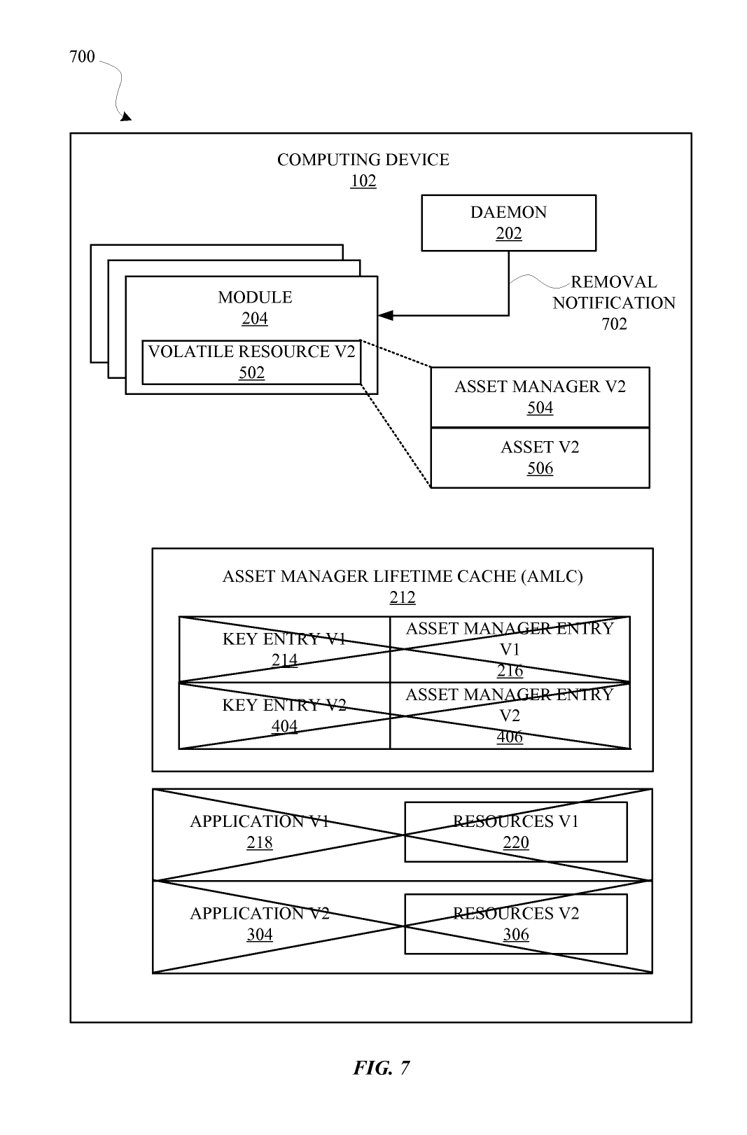

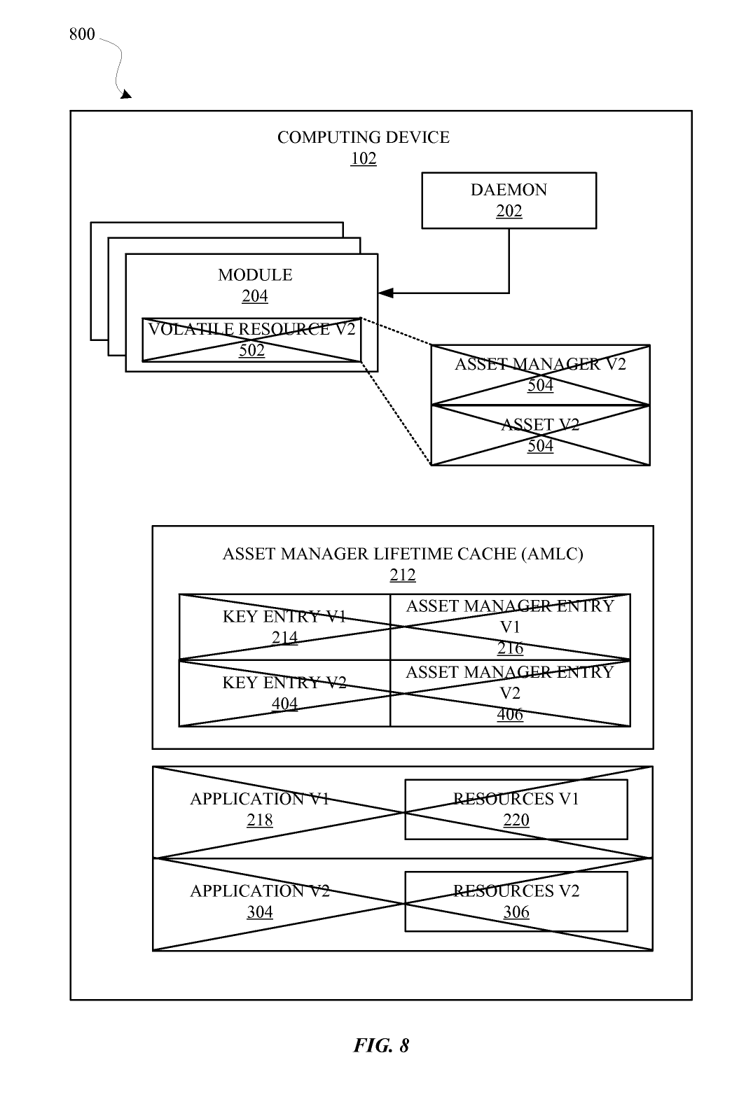

FIG. 7 illustrates a system diagram 700 of the daemon 202 notifying the module 204 that the application V2 304 has been removed from the computing device 102. Specifically, FIG. 7 illustrates how the module 204 can continue using the volatile resource V2 502 even after the daemon 202 has provided a removal notification 702 to the module 204. The removal notification 702 can include information related to the time, version, and former location of the application that has been removed from the computing device 102. By allowing the module 204 to access the asset manager V2 504 and the asset V2 506, the module 204 can avoid crashes, which can result from referencing the path of the application V2 304 or the resources 306. For example, when the module 204 is responsible for managing desktop icons, the module 204 can continue displaying an icon for the application V2 304—even though the application V2 304 was removed—until it is safe to relinquish the volatile resource V2 502, as illustrated in FIG. 8.

FIG. 8 illustrates a system diagram 800 of the module 204 after having relinquished the volatile resource V2 502. The volatile resource V2 502 can be relinquished when the module 204 is performing an operation associated with the volatile resource V2 502, and is aware that the application V2 304 has been removed from the computing device 102. For example, when the module 204 is responsible for managing icons 106 on the display 104 of the computing device 102, the module 204 may only access the asset V2 504 when the display 104 is outputting a home screen. When the home screen is covered by an interface of an application, the module 204 may not relinquish the volatile resource V2 502—despite the application V2 304 being removed from the computing device 102. However, once the home screen is directed to be displayed by the module 204, and after determining that the application V2 304 has been removed from the computing device 102, the module may relinquish the volatile resource V2 502 in order to display a home screen that reflects the removal of the application V2 304.

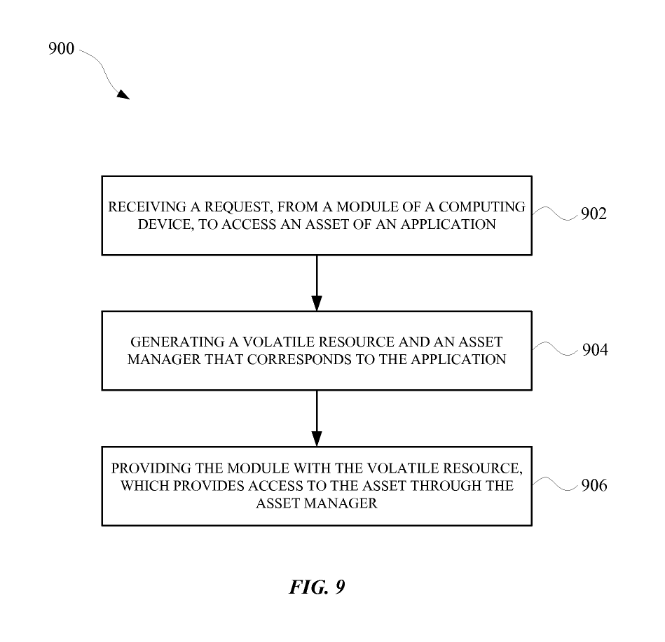

FIG. 9 illustrates a method 900 for providing a volatile resource to a module of a computing device in order for the module to access an asset of an application through the volatile resource. The method 900 can be performed by any module, application, cache, device, apparatus, system, or subsystem that is suitable for assisting in managing assets of an application. For example, the method 900 can be performed by the asset manager lifetime cache 212 discussed herein. The method 900 can include a step 902 of receiving a request, from a module of a computing device, to access an asset of an application. The asset can correspond a portion of data associated with the application. For example, the asset can be an image associated with a home screen icon for the application. Furthermore, the request can include or be encrypted with one or more identifiers for the application including, but not limited to, a bundle identifier, an install path, and a modification time, as discussed herein. The method 900 can also include a step 904 of generating a volatile resource and an asset manager that corresponds to the application. The method 900 can further include a step 906 of providing the module with a volatile resource, which provides access to the asset through the asset manager. In some embodiments, the volatile resource can act to provide the module with access to the asset even when the application has be uninstalled, deleted, or updated to another version.

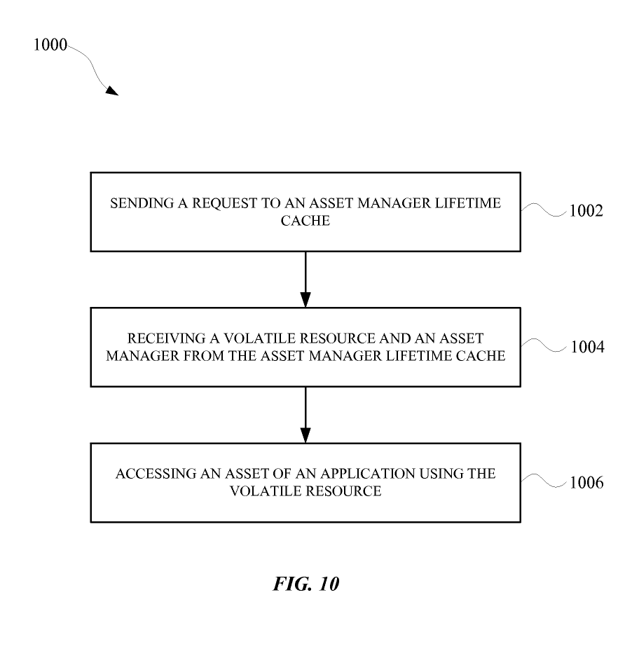

FIG. 10 illustrates a method 1000 for accessing an asset of an application of a computing device using a volatile resource. The method 1000 can be performed by any module, application, cache, device, apparatus, system, or subsystem that is suitable for assisting in managing assets of the application. For example, the method 1000 can be performed by a module that is responsible for managing and arranging application icons on a home screen of a computing device. The method 1000 can include a step 1002 of sending a request to an asset manager lifetime cache (AMLC). For example, the request can be from a module that has determined that an updated version of an application has been installed. Additionally, the request can include data provided by a daemon on the computing device. The data can be used by the AMLC to create a key entry and an asset manager entry for the updated version of the application. Additionally, in response to the request, the AMLC can generate a volatile resource and asset manager for the module to access assets of the updated version of the application. The method 1000 can also include a step 1004 of receiving the volatile resource and the asset manager from the AMLC. The method 1000 can further include a step 1006 of accessing an asset of an application using the volatile resource. By allowing the module to maintain its own asset manager through the volatile resource, the module can independently access assets of an application until it is convenient for the module to request another volatile resource and asset manager. The lifetime of the asset manager can depend on an amount of time that the module is referencing the asset manager, and, therefore, the asset manager can be relinquished once the module has made another request for, and received, a volatile resource and asset manager from the AMLC.

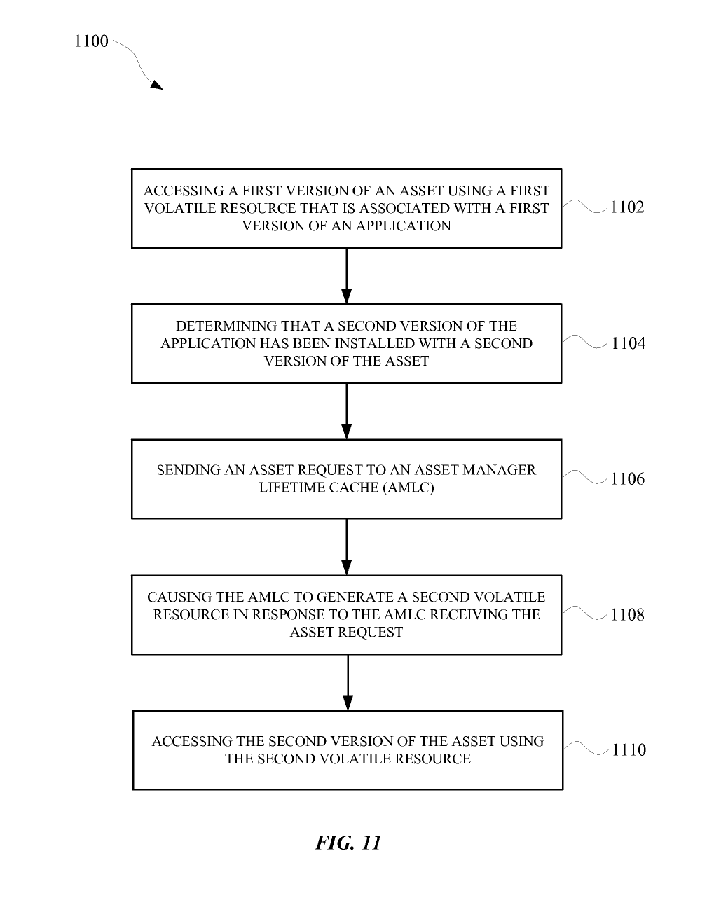

FIG. 11 illustrates a method 1100 for obtaining access to an updated asset of an updated application of a computing device through a volatile resource. The method 1100 can be performed by any module, application, cache, device, apparatus, system, or subsystem that is suitable for assisting in managing assets of an application. For example, the method 1100 can be performed by a module that uses assets of an application during execution of the module. The method 1100 can include a step 1102 of accessing a first version of an asset using a first volatile resource that is associated with a first version of an application. The first version of the asset can refer to a portion of data, such as an icon image or string, that is associated with the first version of the application. At step 1104, a determination is made that a second version of the application has been installed with a second version of the asset. The determination can be based on information from a daemon or other background process that can provide updates regarding when an application has been updated, uninstalled, removed, or otherwise modified. Additionally, the information from the daemon can include one or more identifiers such as an install path for the updated application or a time stamp corresponding to when the updated application was installed. At step 1106, an asset request is sent to an asset manager lifetime cache (AMLC). The asset request can include a key that is generated based on the one or more identifiers provided by the daemon. At step 1108, the AMLC is caused to generate a second volatile resource in response to the AMLC receiving the asset request. Additionally, in response to the asset request, the AMLC can generate a key entry and asset manager entry corresponding to the second version of the application. Furthermore, and in some embodiments, the AMLC can remove a key entry and an asset manager entry corresponding to the first version of the application, in response to the asset request, in order that the AMLC will make a more efficient use of memory where the entries are stored. At step 1110, the second version of the asset is accessed using the second volatile resource provided by the AMLC. Furthermore, the module receiving the second volatile resource can relinquish the first volatile resource. By determining when to relinquish the first volatile resource and use the second volatile resource, the module is able to control when to transition between accessing different assets without causing conflicts or errors at the module and/or computing device.

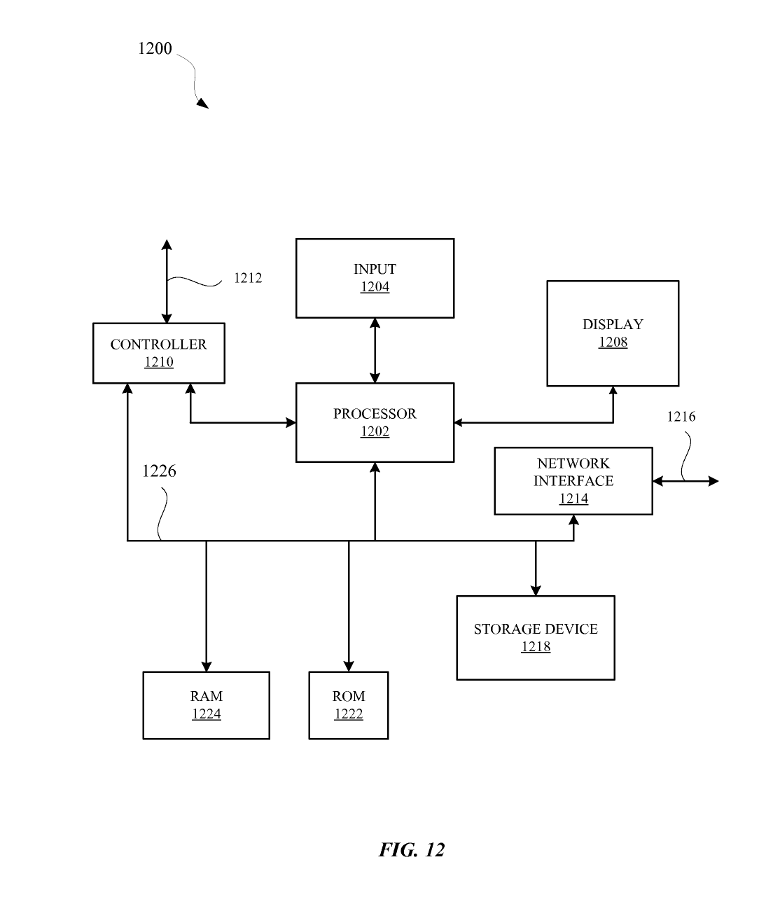

FIG. 12 is a block diagram of a computing device 1200 that can represent the components of the computing device 102. It will be appreciated that the components, devices or elements illustrated in and described with respect to FIG. 12 may not be mandatory and thus some may be omitted in certain embodiments. The computing device 1200 can include a processor 1202 that represents a microprocessor, a coprocessor, circuitry and/or a controller 1210 for controlling the overall operation of computing device 1200. Although illustrated as a single processor, it can be appreciated that the processor 1202 can include a plurality of processors. The plurality of processors can be in operative communication with each other and can be collectively configured to perform one or more functionalities of the computing device 1200 as described herein. In some embodiments, the processor 1202 can be configured to execute instructions that can be stored at the computing device 1200 and/or that can be otherwise accessible to the processor 1202. As such, whether configured by hardware or by a combination of hardware and software, the processor 1202 can be capable of performing operations and actions in accordance with embodiments described herein.

The computing device 1200 can also include user input device 1204 that allows a user of the computing device 1200 to interact with the computing device 1200. For example, user input device 1204 can take a variety of forms, such as a button, keypad, dial, touch screen, audio input interface, visual/image capture input interface, input in the form of sensor data, etc. Still further, the computing device 1200 can include a display 1208 (screen display) that can be controlled by processor 1202 to display information to a user. Controller 1210 can be used to interface with and control different equipment through equipment control bus 1212. The computing device 1200 can also include a network/bus interface 1214 that couples to data link 1216. Data link 1216 can allow the computing device 1200 to couple to a host computer or to accessory devices. The data link 1216 can be provided over a wired connection or a wireless connection. In the case of a wireless connection, network/bus interface 1214 can include a wireless transceiver.

The computing device 1200 can also include a storage device 1218, which can have a single disk or a plurality of disks (e.g., hard drives) and a storage management module that manages one or more partitions (also referred to herein as “logical volumes”) within the storage device 1218. In some embodiments, the storage device 1220 can include flash memory, semiconductor (solid state) memory or the like. Still further, the computing device 1200 can include Read-Only Memory (ROM) 1222 and Random Access Memory (RAM) 1222 and. The ROM 1222 can store programs, code, instructions, utilities or processes to be executed in a non-volatile manner. The RAM 1224 can provide volatile data storage, and stores instructions related to components of the storage management module that are configured to carry out the various techniques described herein. The computing device can further include data bus 1226. Data bus 1226 can facilitate data and signal transfer between at least processor 1202, controller 1210, network interface 1214, storage device 1218, ROM 1222, and RAM 1224.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for using a volatile resource to access an asset of an application, the method comprising:
by a computing device:
receiving a request, from a module of the computing device, to access the asset of the application;
generating the volatile resource and an asset manager corresponding to the application; and
providing the module with the volatile resource that is configured to provide access to the asset via the asset manager.

2. The method of claim 1, wherein the asset manager is generated in response to a determination the asset manager does not exist for the application.

3. The method of claim 1, wherein the request includes a key that is generated using time data associated with a time of a most recent update of the application.

4. The method of claim 1, wherein the request includes a key that is generated using address data associated with a location of the application.

5. The method of claim 1, further comprising:
determining that the application has been uninstalled; and
removing, from a cache, an entry corresponding to the asset manager in response to the application being uninstalled.

6. The method of claim 5, wherein the volatile resource remains accessible to the module after the application has been uninstalled.

7. The method of claim 1, wherein the module is configured to manage icons for a display of the computing device, and the asset corresponds to at least one of the icons.

8. A computing device comprising:
a processor; and
a memory configured to store instructions that when executed by the processor cause the computing device to perform steps that include:
by a module of the computing device:
sending an asset request to an asset manager cache; and
receiving a volatile resource from the asset manager cache, wherein the volatile resource:
references an asset and an asset manager, wherein the asset manager is created by the asset manager cache, and
provides the module access to the asset of an application.

9. The computing device of claim 8, wherein the asset request includes a key that is generated based on an identifier of the application and an installation path of the application.

10. The computing device of claim 8, wherein the asset request includes a key that is generated based on time data corresponding to a time when an installation path of the application was last modified.

11. The computing device of claim 8, wherein the steps further include:
determining that an application update has been installed at the computing device, wherein the application update corresponds to an updated version of the application; and
providing an updated asset request to the asset manager cache, wherein the updated asset request includes a different key than a key of the asset request.

12. The computing device of claim 11, wherein the steps further include:
causing the asset manager cache to generate an updated asset manager in response to the updated asset request.

13. The computing device of claim 8, wherein the asset corresponds to an icon, and the module manages an arrangement of the icon at a display of the computing device.

14. A system for managing application assets on a computing device, the system comprising:
an asset manager cache configured to generate a volatile resource in response to an asset request, wherein the volatile resource is configured to provide access to an asset associated with an application on the computing device; and
a module configured to provide the asset request to the asset manager cache and access the asset using the volatile resource, wherein the volatile resource is available to the module regardless of whether the application is updated or removed.

15. The system of claim 14, wherein the asset manager cache is further configured to:
store at least one entry corresponding to an asset manager for the application, and
remove the at least one entry when an updated version of the application has been installed on the computing device.

16. The system of claim 14, wherein the asset manager cache is further configured to:
store at least one entry corresponding to an asset manager for the application, and
generate a new entry corresponding an updated version of the application, wherein the new entry is generated in response to the module providing an updated asset request to the asset manager cache.

17. The system of claim 16, wherein the asset manager cache is further configured to generate an updated volatile resource in response to the updated asset request, and the volatile resource is removed from the system in response to the updated volatile resource being provided to the module.

18. The system of claim 14, wherein the module is configured to manage the arrangement of icons on a display of the computing device.

19. The system of claim 14, wherein the asset manager cache includes entries that each correspond to different versions of different applications.

20. The system of claim 14, wherein the asset is an image, sound, or string.
